(19) United States
(12) Patent Application Publication
(10) Pub. No.: US 2015/0107319 A1
(43) Pub. Date: Apr. 23, 2015

(54) ALKALINE HYDROLYSIS OF ORGANIC WASTE INCLUDING SPECIFIED RISK MATERIALS AND EFFLUENT DISPOSAL BY MIXING WITH MANURE SLURRY

(71) Applicants: Richard Vonderwell, Delphos, OH (US); Eric Fritz, Delphos, OH (US); Nathan Metz, Ada, OH (US)

(72) Inventors: Richard Vonderwell, Delphos, OH (US); Eric Fritz, Delphos, OH (US); Nathan Metz, Ada, OH (US)

(73) Assignee: BARNYARD TECHNOLOGIES LLC, Delphos, OH (US)

(21) Appl. No.: 14/058,684

(22) Filed: Oct. 21, 2013

(51) Int. Cl. C05F 3/00; C05F 17/00

(52) U.S. Cl. CPC C05F 3/00; C05F 17/009
USPC 71/10; 435/262.5; 71/21

(57) ABSTRACT

A method for sterilization of pathogenic waste includes steps of introducing animal tissues, carcasses or parts, pathogenic waste, or by-products of slaughter or processing into an unpressurized vessel, adding NaOH and KOH in a ratio of about 2.2 to 2.3:1, adding water sufficient to create a 1.5 to 1.6 Molar solution, such that the tissue to water ratio is about 1:1.5, heating the vessel indirectly to near but below the boiling point of the solution, holding the temperature for about 16-20 hours, while continuously agitating the contents of the vessel, displacing the solution volume in the reaction vessel about every 2-3 minutes. Optimally, the tissue is introduced into the vessel first, then dry NaOH and KOH, and finally water. The end product is a homogenous, aqueous solution that is sterile, pathogen-free and suitable for land application or mixing directly into manure retention vessels, prior to land application of the mixture.

### BACKGROUND OF THE INVENTION

1. Field of the Invention

The invention pertains generally to the field of decontamination and disposal of potentially infectious organic waste materials. More particularly, the invention pertains to methods and apparatus for sterilizing organic animal wastes, including specified risk materials, destroying TSEs and/or other pathogens by alkaline hydrolysis, and disposing of the sterilized end product, preferably by mixing the alkaline hydrolysis effluent into manure retention vessels prior to land application of the mixture.

2. Description of Related Art

The disposal of animal manure and animal carcasses and other potentially pathogenic wastes and by-products of animal production and processing has always presented challenges. Modern agricultural techniques that involve confinement of farm animals have further increased the environmental problems associated with animal waste disposal. These problems are encountered in all types of animal production, including, for example, hog farming, feedlot cattle farming, poultry farming and many others. The problem is particularly prevalent among that portion of the agricultural industry that pertains to confined animal feeding operations, such as those typically used for dairy, poultry and swine production. In particular, the storage and treatment of manure and the management, processing and disposal of manure is one of the most difficult, expensive and potentially limiting problems facing the agricultural industry.

Animal manure contains high amounts of nitrates and salts, as well as other compounds such as pharmaceuticals, much of which derives from the animal feed. These contents make manure and its effluent undesirable for contact with fresh water sources, such as rivers and underground aquifers, and difficult to treat or remove, once they contaminate fresh water. Although many of these components of animal manure are valuable nutrients that can be highly useful as soil amendments, for safety and to comply with various regulations, raw animal manures normally are processed and preferably should be sterilized, before being applied to agricultural soils or crops, particularly if intended for human or food-animal consumption. Indeed, most developed-economy countries have numerous statutes and regulations that place rigorous restrictions on the use of animal manures, particularly with crops intended for human and animal consumption or contact.

In one common method of operation, manure handling in confined animal feeding operations consists of a mechanical or hydraulic flushing system that flushes the animal manure from the animal holding area to deliver the manure, typically as a slurry, to a storage area, where the slurry is stored, before ultimately being applied as fertilizer or in conjunction with irrigation. The storage areas for animal waste handling systems usually consist of lagoons, ponds, pits or similar surface storage areas that typically are located on or near the agricultural property on which the manure is generated. The basic function of the lagoons or basins is to store and treat high-strength liquid waste, such as the wastewater, livestock manure, etc., to control unwanted odors and to process the waste for ultimate recycling in the environment. Manure from these lagoons often is used to irrigate agricultural crops, typically after being mixed with four to five parts of fresh water for every one part of recycled water.

In regions where the soil is not already alkaline, some form of lime typically is added to agricultural fields on a regular basis to maintain the given range of soil pH considered optimal for plant growth. This need for lime application is increased, when livestock manure is land-applied, due to the acidic pH of the manure itself. Furthermore, when subjected to the effects of anaerobic bacteria, the need for liming is significantly increased even further. This is because during storage, in the absence of oxygen, the manure slurry proceeds through the four stages of anaerobic digestion: 1) hydrolysis, 2) acidogenesis, 3) acetogenesis and finally, 4) methanogenesis. Throughout these stages the acidity of the manure slurry increases as a by-product of the anaerobic digestion process. Thus, relatively more lime ultimately is required to neutralize the acidity of anaerobically digested manure that has been stored.

One major trend in the livestock industry, which has compounded this issue, is the movement toward larger buildings and larger manure retention pits. In the past, smaller buildings had smaller manure retention pits, which required more frequent emptying of the pits and lagoons. Typically, buildings had to be emptied three or four times per year. Current operations frequently have sufficient storage capacity to require only annual emptying, which means that the manure is subjected to a much longer term in an anaerobic environment. Thus the need for lime application is increased even more, after the decrease in pH due to the anaerobic digestion of the manure slurry.

Another major animal waste disposal challenge in agriculture pertains to the disposal of animal carcasses and other potentially pathogenic waste and by-products of animal production and meat processing. Each year millions of animals, including, but not limited to mammals, birds, fish and invertebrates are killed by natural disasters, such as floods and hurricanes, man-made disasters, such as oil and chemical spills, or by diseases, such as foot and mouth disease, avian influenza, Newcastle disease and Transmissible Spongiform Encephalopathies (TSEs, e.g., Bovine TSE or mad cow disease). Events such as these create the need to quickly and safely destroy large numbers of dead and/or diseased animals to prevent the spread of infection to other animals, including humans. Additionally, many animal-based agricultural activities, such as commercial egg production, meat and poultry processing and commercial fishing and fish farming regularly produce large volumes of animal carcasses and animal by-products that must be disposed of safely and quickly.

In some instances, animal tissues to be disposed of are classified as regulated medical waste. Regulated medical waste (RMW), and pathologic wastes and chemotherapeutic wastes (PCW), generally are separated from other contaminated components of medical waste and, in most jurisdictions, can only be treated and disposed of by incineration. The developing enforcement regulations derivative from the Clean Air Act and the growing public resistance to the incineration of all RMW, especially the burning of pathogenic and chemotherapeutic wastes (PCW), makes the need for development of safe and efficient alternative technologies for treatment of such wastes a primary concern of the healthcare industry. Currently there are several acceptable technologies for the treatment and disposal of ordinary RMW, but there is no accepted alternative technology to incineration for disposal of PCW. Currently, all pathologic wastes and chemotherapeutic wastes must be incinerated.

Furthermore, the increase in major infectious diseases threatening human and animal health also has led to new international regulations and laws which prohibit the use of carcasses, animal by-products, food waste and other certain “Specified Risk Materials” (SRM), as defined in various jurisdictions, for use as human food, feed for animals and as feedstock for rendering plants, which normally would convert these materials into meat and bone meal (MBM) and other animal nutrient products (fats and blood meal, etc.). The onset of novel variants and expansion of TSEs or prion diseases, such as bovine spongiform encephalopathy (BSE), chronic wasting disease (CWD), and scrapie, as well as emerging viral diseases in poultry and other animals, has created serious problems regarding the disposal or recycling of these materials. Regulatory authorities need to assure the public that they are eliminated from human and animal food chains. Although not considered to be highly contagious, prion diseases are of particular concern, because certain high-risk tissues, including the brain, spinal cord, cerebral spinal fluids, and the eye, can transmit them. Iatrogenic transmission has been reported during several procedures, including dura-mater grafting, corneal transplants, pericardial homografts, through human gonadotropin and human growth hormone contamination and blood transmission also have been reported. Thus SRMs are highly regulated in most jurisdictions now. In the United States, for example, the federal Food Safety Inspection Service (FSIS) has issued a series of final rules to minimize human exposure to SRMs that scientific studies have demonstrated have the potential to contain the BSE agent in cattle infected with that disease. See 9 C.F.R. §§309, 310 and 313.

The most common method currently in use for disposal of large volumes of animal carcasses and animal by-products is burial, however, incineration and rendering also play a role. Burial isolates the animal tissue underground, but traditional disposal by burial and composting does not destroy the most resistant pathogens (BSE, anthrax, etc.). Furthermore, burial leads to decomposition of the animal tissue and an attendant environmental degradation and risk of contamination and further spread the disease. However, burial currently is by far the most common method for disposal of SRM.

Incineration is one disposal method that offers the advantage of destroying some or, in some cases, all pathogens present in animal tissues. However, incineration of large volumes of animal material generally is performed in open trench fires or air curtain burners and, under such open-air conditions, produces significant air pollution and the possibility of airborne spread of pathogens not destroyed by combustion. Thus, incineration of large amounts of animal carcass, food and other wastes creates secondary environmental pollution and potentially toxic effects. Additionally, incineration requires large amounts of fuel to generate the high temperatures necessary to destroy animal tissue, as well as large areas of land, where the open burning can take place.

Rendering is a method of cooking animal tissues to reduce their volume before burial or other land-based disposal and also is impractical in situations where large numbers of animals must be processed quickly. Rendering requires large, fixed facilities such that the animal material usually must be transported to the rendering facility before processing. Moreover, the high temperature and pressure conditions considered necessary for TSE inactivation are not readily achievable using standard rendering or animal waste recycling equipment. Also, high temperature treatments tend to produce unwanted by-products, such as carcinogens, di-amino acids and volatile odors. Furthermore, SRMs generally are prohibited for use as a feedstock for rendering plants.

Generally, it has been concluded that the destruction of TSEs in meat requires treatment at 132 degrees C. for 20 minutes under 3 bars pressure. Alternatively, in the presence of alkali the temperature and pressure may be reduced to 121 degrees C. and 2 bars respectively. However, both of these processes require a sustained temperature well above 100 degrees C. as well as pressure.

According to the USDA and APHIS the use of alkaline hydrolysis tissue digesters now is the preferred method for disposal of BSE-contaminated carcasses. Research has demonstrated that alkaline hydrolysis is effective in significantly reducing the infectivity of the prion causing BSE as well as in destroying the infectivity of bacteria and viruses. Most recently the Department of Natural Resources in both Pennsylvania and Maryland used a portable alkaline hydrolysis unit to process deer carcasses to combat CWD in their infected herds during the 2012-2013 seasons. Both CWD and BSE are a result of prion infestation. However, current methods that employ alkaline hydrolysis require high temperature and/or pressure.

Alkali is known for its hydrolytic effect on biomolecules, such as proteins, and efforts to sterilize animal tissues contaminated with TSE have utilized alkali treatment, heat and pressure as means for destroying prion pathogenicity. For example, Taguchi et al., 1991, Arch. Virol. 119 297 used a 1 hour treatment with 1 N NaOH followed by autoclaving at 121 degrees C. for 30 minutes to inactivate CJD-infected brain homogenates. Ernst & Race, 1993, J. Virol. Methods 41 193 employed autoclaving together with NaOH and LpH treatment to inactivate scrapie-infected brain homogenates. A more extensive series of tests was performed by Taylor et al., 1994, Arch. Virol. 139 131 to decontaminate BSE-infected bovine brain or scrapie-infected rodent brain samples. Treatments included 1 M or 2 M NaOH for up to 1 hour, autoclaving at temperatures between 134 degrees C. and 138 degrees C. for up to 1 hour, or treatment with sodium hypochlorite or sodium dichloroisocyanurate for up to 2 hours. However, these authors concluded that none of the procedures tested produced complete TSE inactivation.

Various methods intended for the deactivation of TSEs and the disposal of pathogenic organic waste have been disclosed in the prior art. For example, U.S. Pat. No. 8,293,174 discloses prion deactivating compositions and methods for using the same. This prion deactivating composition requires at least one prion denaturing agent and at least one prion deactivating enzyme.

U.S. Pat. No. 8,278,081 discloses a method for producing a hydrolyzed, sterile, denatured product from infectious organic waste material that includes (a) introducing, into a reactor capable of being heated and pressurized, infectious organic waste material to form a reaction mixture; (b) subjecting the reaction mixture to saturated steam at a temperature and pressure within the reactor for a duration of time sufficient to thermally hydrolyze and denature the reaction mixture into a denatured slurry; and (c) alternatively (1) anaerobically digesting the denatured slurry, or (2) fractionating the denatured slurry based on molecular weight, density and size into at least two hydrolyzed, sterile, denatured products. The resulting hydrolyzed, sterile products are alleged to have safe and valuable nutritional properties and may be used in a wide range of commercial, agricultural, and industrial products or processes. The process is cumbersome, as it requires live steam, high-pressure and high-temperature, and must be followed by anaerobic digestion or fractionation.

U.S. Pat. Nos. 8,075,939 and 7,618,673 disclose methods for producing a fertilizer and an animal feed that are free from transmittable degenerative encephalopathies. Central to the method is the alkali treatment of animal material at a pH of at least 8.5 under temperature conditions below 100 degrees C. at atmospheric pressure, followed by dehydration. This method provides a decontaminated animal feed produced under relatively low temperature and pressure conditions that are achievable in standard animal carcass rendering facilities. This process is a dry process that does not include the addition of water and thus does not employ alkaline hydrolysis. Furthermore, the method requires a dehydration step in order to render the TSEs inactive.

U.S. Pub. No. 20070197852A1 discloses a method for the treatment of potentially infectious biological waste material, including diseased animal carcasses, by comminuting the waste material, mixing the waste with a strong alkaline material and heating. Apparatus for practicing the method wherein biological waste is comminuted, hydrolyzed using a strong alkaline material, and heated by an apparatus mounted to a movable platform also are disclosed. This process requires the additional steps of grinding and dehydrating the organic waste.

Thus, although there are known processes that are intended to aid in destroying TSEs in animal waste materials, the prior art suffers from a number of limitations, such as requiring either enzymes, high temperature (above 100 degrees C.) and/or high pressure, grinding and/or dehydration to achieve inactivation of TSEs.

There presently exists a need for technologies that safely eliminate the health and environmental risks created by SRMs and other infectious or potentially infectious organic materials, without the negative impacts of contamination, pollution and odors associated with traditional methods of rendering, burial and burning. A further need exists for efficient methods for processing and disposal of large volumes of animal by-products and/or dead or diseased animals. There is also a need for a processing method that destroys or otherwise neutralizes any actual or potential pathogens associated with the dead or diseased tissues, such as TSEs. There is further a need for alternative methods for the safe, effective, and economical treatment and disposal of large volumes of such wastes, as well as other agricultural wastes, including manure produced in association with large animal production facilities, as well as a need for methods to minimize liming applications normally associated with land-based disposal of anaerobically fermented agricultural and municipal waste.

### SUMMARY OF THE INVENTION

The invention pertains generally to the field of decontamination and disposal of potentially infectious organic waste materials. More particularly, the invention pertains to methods and apparatus for sterilizing organic animal wastes, including Specified Risk Materials, destroying TSEs and/or other pathogens by alkaline hydrolysis, and disposing of the sterilized end products preferably by mixing the alkaline hydrolysis effluent into manure retention vessels prior to land application of the mixture.

The inventor discloses herein a novel solution to numerous problems in modern agriculture. The methods disclosed herein provide for disposal of large volumes of animal by-products and/or dead or diseased animals, provide a processing method that destroys any actual or potential pathogens associated with the dead or diseased tissues, such as TSEs, and further provide alternative methods for the safe, effective, and economical treatment and disposal of large volumes of such wastes, as well as methods to minimize liming applications normally associated with land-based disposal of anaerobically fermented agricultural and municipal wastes. By mixing the highly alkaline effluent derived from the alkaline hydrolysis of animal carcasses or SRM waste directly into the acidic environment of the agricultural or municipal manure pit in situ, numerous unforeseen advantages are realized. The process provides efficient, safe and cost effective means for disposal of large volumes of SRM waste, as well as animal manures, while reducing or eliminating the need for additional lime application and thereby saving fuel and labor.

Briefly stated, a method for the sterilization of organic waste includes the steps of introducing an organic waste material for disposal into an unpressurized reaction vessel, adding NaOH and/or KOH plus water to the vessel, heating the vessel to a temperature below but near the boiling point of the resulting solution, and holding the temperature for at least 16 hours, while agitating the contents of the vessel, thereby producing a sterile, pathogen-free, homogenous, aqueous solution that is suitable for land application or mixing into manure retention vessels prior to land application of the mixture.

Although practically any organic waste is suitable, a preferred embodiment provides a method that includes the steps of introducing an organic waste material for disposal into a reaction vessel, wherein the organic waste includes one or more animal tissues, carcasses or a part thereof, pathogenic animal waste or a by-product of animal slaughter or processing, wherein NaOH and KOH are added in a ratio of about 2.2 to 2.3:1, and wherein sufficient water is added to create a 1.5 to 1.6 Molar basic solution. The tissue to water ratio preferably is about 1:1.5. Preferably the tissue is introduced into the reaction vessel first, then the dry NaOH and KOH, and finally the water. The reaction vessel preferably is heated indirectly and the agitation preferably is sufficient to displace the volume of solution in the reaction vessel about every 2-3 minutes. The temperature preferably is held for 16 to 20 hours.

An alternative embodiment provides a method for in situ pH manipulation of manure in anaerobic manure retention facilities, prior to land application of the pH-adjusted manure slurry. The process is not limited to the use of effluent from alkaline hydrolysis, as any alkaline slurry that is safe and approved for land application can be used to manipulate the pH of the manure slurry, while in confinement and prior to application (instead of counteracting the acidity of the product after land application).

Another alternative embodiment provides an energy source for anaerobic digesters for potential electricity production. By using the alkaline hydrolysis effluent as an energy source in an anaerobic digester, the first stage of the anaerobic digestion process (hydrolysis) can be accelerated, reducing the overall time from hydrolysis to methanogenesis, thereby producing the same amount of energy in a shorter period of time.

The system thus provides a novel solution to numerous problems in modern agriculture, as described in further detail below. The methods disclosed herein provide for disposal of large volumes of animal by-products and/or dead or diseased animals, provide a processing method that destroys any actual or potential pathogens associated with the dead or diseased tissues, such as TSEs, and further provide alternative methods for the safe, effective, and economical treatment and disposal of large volumes of such wastes. A further advantage is that the end product is suitable for land or municipal sewage system disposal and optionally can be mixed directly into manure lagoons to adjust the pH of the manure slurry, prior to land application of the mixture, thereby decreasing or eliminating the need for liming applications normally associated with land-based disposal of anaerobically fermented agricultural and municipal wastes. These and other features and advantages will become readily apparent from the following Detailed Description, which should be read in conjunction with the accompanying drawing figures.

### DETAILED DESCRIPTION

The following description relates to certain preferred embodiments of methods and apparatus in accordance with the present invention. It will be readily apparent that numerous variations and modifications other than those specifically indicated will be readily apparent to those of sufficient skill in the field. In addition, certain terms are used throughout the discussion in order to provide a convenient frame of reference. These terms are not intended to be specifically limiting of the invention, except where so indicated in the claims.

Provided herein is a method for alkaline hydrolysis of animal (pet) carcasses, which produces an end product that is a homogenous, nutrient-rich, sterile liquid that is also highly alkaline. The inventor has developed a process that combines alkaline hydrolysis with new technologies and better chemistry to achieve the complete destruction of pathogens, including TSEs, at low temperature (below boiling) and atmospheric pressure. Prior art systems currently require high temperature (above 100 degrees C.) and pressure, typically operating at approximately 350 degrees F. and 15 pound per square inch of pressure, and other known processes further require grinding and/or dehydration to achieve complete inactivation of TSEs.

In alkaline hydrolysis, sodium hydroxide or potassium hydroxide, or a combination of the two, is used as the agent that, under heat or heat and pressure, breaks down carcass tissues, leaving only liquid effluent and the mineral portion of bone and teeth. The effluent typically has a very high pH ranging from 10.5 to 11.7 and therefore, in most cases, can be discharged into municipal sewage systems. The bone and teeth easily can be crushed into a fine powder and land applied or sent to a landfill.

Alkaline hydrolysis tissue digesters originally were developed to dispose of radioactive animal carcasses generated from biomedical and pharmaceutical research and development. The commercially available equipment for alkaline hydrolysis was originally designed for permanent installation in a building with a controlled environment. Equipment usually was expensive and often cost prohibitive for general carcass disposal. However, recent advances in technology and equipment development have made this method of carcass disposal an option in situations in which more common disposal methods are infeasible. Better engineering has greatly reduced the capital cost of such machines and portable units now are available that operate in most any environment.

Alkaline hydrolysis tissue digesters come in variable shapes and sizes based on the volume of tissue to be processed, but the process chemistry is always the same. A measured amount of alkali and water are added to the vessel proportional to the weight of the tissue, and then heated and agitated. According to WR2, one individual can load and operate an alkaline hydrolysis unit. Once the system is loaded with tissue, the alkali and water can be added via computer control without exposure to individuals. The automated system then heats and agitates the contents of the vessel for the duration of the cycle. The resulting effluent is then emptied by a closed pump system into sanitary sewer for disposal. At no time during the cycle is there exposure to alkali or the contents of the vessel by personnel. The process releases no emissions into the atmosphere and results in only a mild odor as the digestion process progresses. The end product is a sterile, coffee-colored effluent.

### EXAMPLE 1

### Alkaline Hydrolysis for Animal Carcass and SRM Disposal

In one example illustrating an embodiment, a 4,000 pound load of pet carcasses is loaded into a reaction vessel of suitable size. Although pet carcasses are used in this example, practically any organic animal or plant tissue normally would suffice. Cutting or grinding of the carcasses is not required. Added to the vessel are 250 pounds of NaOH and 110 pounds of KOH and enough water to make a 1.5 to 1.6 Molar solution. The basic solution must be at least 1.0 Molar, however 1.5 to 1.6 Molar is preferred. The tissue to water ratio preferably is approximately 1-1.5:1 weight basis. The Na/K ratio is important for viscosity and particularly later for land application to avoid burning crops. A Na:K ratio of about 2.2:1 is optimal and allows the end product to be sprayed directly on hay crops between cuttings. Preferably the animal tissue is loaded first, then the dry chemicals and finally the water. There is no need for pressure thus process is not pressurized. Preferably the reaction vessel is heated indirectly, such as by heat tubes in the bottom of the vessel, to warm the tank to optimal temperature, which is just below the boiling point of the solution. The heat is merely the catalyst for the reaction. However, boiling causes steam vapor, which reduces the water volume over time and can potentially limit hydrolysis. It is therefore optimal to avoid boiling. The optimal temperature is about 205-206 degrees F. or about 96-97 degrees C.

The vessel contents are agitated, such as by locating boat props at each end of the reaction vessel, with the total tank volume being displaced preferably every 2-3 minutes. The agitation ensures that the tissue is exposed to alkali and water along with even heating. The temperature is then maintained at near and preferably just below boiling point, with constant agitation for approximately 16-20 hours. At the end of the cycle, the end product is a highly alkaline, homogenous aqueous solution that contains some precipitated solids (calcium phosphate). The end product is sterile and the effluent pH ranges from approximately 10.5 up to 11.3. It is safe for land application and/or sewer discharge. The University of Maryland spread the effluent on soccer and baseball fields during testing. The inventor also made land applications in varying crops for two years with surprising results.

The key to the hydrolysis reaction is water, which is required for the reaction of the alkali with the protein (around 22 percent) in the tissue. If any of the three becomes limiting, the reaction reaches equilibrium (i.e., before complete hydrolysis). Hydrogen from the water is separated from the oxygen via the alkali and is then forced between the membrane and the nucleus of the tissue cells. Thus the cells and their components are denatured and fragmented. Prions in SRMs can withstand 1,600 degrees F. for hours in an incinerator and still be viable. However, the same prion exposed to a 1 Molar solution of alkali at room temperature lasts only one minute. The process also denatures the drugs used in euthanasia and other applications within the pet and agriculture industry. The entire process is green friendly with zero emissions.

Currently landfills in the United States take in approximately 1.6 billion pounds of SRMs and 17 million dogs (at 40 pounds each, average) that end up going to waste each year. Using the methods disclosed herein, this waste could instead be processed and put to valuable use as nutrients that are otherwise wasted and lost each year. This use can include, for example, direct land application, pH manipulation within agriculture and human waste containment facilities, and nutrient enhancement for anaerobic digestion operations and composting facilities.

Implementing the process of alkaline hydrolysis within slaughterhouses for the treatment and disposal of SRM's would eliminate the need to transport the potentially pathogenic waste off site, reduce landfill accumulation, and allow for the recycling of both macro and micronutrients that are currently wasted. The process is cost effective and environmentally friendly, particularly when compared to other disposal processes and especially when compared with burial in landfills.

### Example 2

### In situ pH Manipulation of Manure in Anaerobic Lagoons

In a second example illustrating an alternative embodiment, provided herein is a process of pH manipulation in manure retention facilities, prior to land application of the manure slurry. The process is not limited to the use of effluent from alkaline hydrolysis, as any alkaline slurry that is safe and approved for land application can be used to manipulate the pH of the manure slurry, while in confinement and prior to application, instead of counteracting the acidity of the product after land application.

Long winters and wet springs in the field often require disposal alternatives to the usual methods for spreading manure or slurries. Particularly in such conditions, the alternative methods preferably do not require storage or re-handling of effluent. In accordance with Example 1, pet carcasses are processed through a process of alkaline hydrolysis to provide an end product that is a homogenous, nutrient rich, sterile liquid that is also very alkaline. The inventor's experiments show that coupling the very basic effluent of Example 1 with the acidic environment of manure retention pits provides an ideal solution to this problem (actually two problems). The alkaline hydrolysis effluent is very useful in the manipulation of pH within manure lagoons in agriculture, or municipal wastewater retention lagoons. In either case the addition of effluent from the alkaline hydrolysis process can greatly reduce or eliminate the need for pH adjustment. Disposal is available to farmers, regardless of the forecast, and the farmers can spread manure slurry that is near pH neutral (pH 7) or slightly above, with no need to apply lime, saving a significant cost. Thus an added bonus is reduced compaction of the soil, as well as recycling of the nutrients within the effluent. The pH manipulation within the retention pits is easy to calculate based on manure volume, current pH, desired ending pH, and the starting pH of the effluent.

In agricultural lagoons pH is ever decreasing under anaerobic conditions, with swine pits ranging from 5.8 to 6.2 and cattle pits ranging from 6.6 to 7.2. The common practice is the application of lime over fields to counteract the low pH of the manure that has been land applied. Effluent applied within the pits, prior to the spreading of the manure slurry, can adjust pH to within a desired range and eliminate the need for manipulation after land application from the pits or lagoons. At a ratio of 20 parts cattle manure slurry to 1 part alkaline hydrolysis effluent, pH was raised by as much as 1.3 bringing the slurry mix to well above the neutral pH level of 7. At a 10 to 1 ratio, the same slurry mix went up as much as 2.4 on the pH scale. Roughly the same results are found with pig manure slurry. The noted difference between starting pH for pig vs. cattle manure is from the animal source itself. Pigs are monogastric (single stomach), while cattle are ruminants, whose digestion is a result of fermentation. Ruminants' gastric systems therefore naturally operate at higher pH than monogastrics.

The same application of alkaline hydrolysis effluent can be used in municipal wastewater treatment plants. Water entering the plant from holding lagoons generally must have its pH raised to within a given range to allow for treatment. As with agricultural lagoons, the pH manipulation can take place prior to the waste entering the treatment facilities. Direct land application of effluent adds micronutrients back to the soil and helps manage pH. Based on analysis the optimal application rate for soybeans is around 1,800 gallons per acre, while corn is 2,400 gallons per acre. Optimal rates for any crop will vary with crop type, soil quality, and weather conditions.

### Example 3

### Energy Source for Anaerobic Digesters and Electric Production

There are four stages in the process of anaerobic digestion, with the final product going through stabilization at methanogenesis with the production of CO2 and methane gas, which can be burned for energy. The first step, however, is hydrolysis. It often is the longest of the four stages. By using the effluent of Example 1 as an energy source in an anaerobic digester, the first stage of the process (hydrolysis) can be accelerated, reducing the overall time from hydrolysis to methanogenesis, thereby producing the same amount of energy in a shorter period of time.

It is to be understood that the architectural and operational embodiments described herein are exemplary of a plurality of possible arrangements to provide the same (or equivalent) general features, characteristics, and general system operation. Therefore, while there have been described the currently preferred embodiments of the present invention, those skilled in the art will recognize that other and further modifications may be made, without departing from the spirit of the present invention, and it is intended to claim all modifications and variations as fall within the scope of the appended claims. Accordingly, it must further be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for adjusting pH of a manure slurry, comprising the steps of:
a) providing a manure slurry held in any manure retention structure;
b) providing an aqueous alkaline solution and mixing said solution directly into said manure slurry in an amount sufficient to adjust pH of said final mixture in said retention structure to within a desired predetermined pH range; and
c) whereby said final mixture is suitable for land application.

2. The method of claim 1, wherein said aqueous alkaline solution comprises NaOH and/or KOH and water sufficient to create at least a 1.0 Molar basic solution.

3. The method of claim 2, wherein said aqueous alkaline solution comprises a NaOH:KOH ratio of about 2.0-2.5:1.

4. The method of claim 2, wherein said aqueous alkaline solution comprises a NaOH:KOH ratio of about 2.2-2.3:1.

5. The method of claim 1, wherein said solution is at least a 1.5 to 1.6 Molar basic solution.

6. The method of claim 5, wherein said aqueous alkaline solution comprises a NaOH:KOH ratio of about 2.0-2.5:1.

7. The method of claim 5, wherein said aqueous alkaline solution comprises a NaOH:KOH ratio of about 2.2-2.3:1.

8. The method of claim 3, wherein said alkaline solution comprises a sterile, pathogen-free, homogenous, aqueous solution effluent produced by alkaline hydrolysis of organic waste including one or more animal tissues, carcasses or a part thereof, pathogenic animal waste or a by-product of animal slaughter or processing.

9. The method of claim 6, wherein said alkaline solution comprises a sterile, pathogen-free, homogenous, aqueous solution effluent produced by alkaline hydrolysis of organic waste including one or more animal tissues, carcasses or a part thereof, pathogenic animal waste or a by-product of animal slaughter or processing.

10. The method of claim 8, wherein said organic waste includes one or more Specified Risk Materials.

11. The method of claim 9, wherein said organic waste includes one or more Specified Risk Materials.

12. The method of claim 3, wherein said alkaline solution is mixed into said manure slurry in a ratio of about 1 part alkaline solution per 10-20 parts manure slurry.

13. The method of claim 6, wherein said alkaline solution is mixed into said manure slurry in a ratio of about 1 part alkaline solution per 10-20 parts manure slurry.

14. The method of claim 8, wherein said alkaline solution is mixed into said manure slurry in a ratio of about 1 part alkaline solution per 10-20 parts manure slurry.

15. The method of claim 9, wherein said alkaline solution is mixed into said manure slurry in a ratio of about 1 part alkaline solution per 10-20 parts manure slurry.

16. The method of claim 12, further comprising the step of disposing of said mixture by land application or mixing into an anaerobic digester as a means for accelerating digestion.

17. The method of claim 13, further comprising the step of disposing of said mixture by direct land application or mixing into an anaerobic digester as a means for accelerating digestion.

18. The method of claim 14, further comprising the step of disposing of said mixture by direct land application or mixing into an anaerobic digester as a means for accelerating digestion.

19. The method of claim 15, further comprising the step of disposing of said mixture by direct land application or mixing into an anaerobic digester as a means for accelerating digestion.

20. The method of claim 3, wherein said adjustment of said manure slurry pH to within said desired predetermined pH range reduces or eliminates further need for adjustment of soil pH due to manure acidity.

21. The method of claim 8, wherein said adjustment of said manure slurry pH to within said desired predetermined pH range reduces or eliminates further need for adjustment of soil pH due to manure acidity.
